(19) United States
(12) Patent Application Publication
(10) Pub. No.: US 2006/0154008 A1
(43) Pub. Date: Jul. 13, 2006

(54) Glass tube, method of manufacturing the glass tube, and method of adhering the glass tube

(75) Inventors: Kazuyuki Suzuki, Chiba-ken (JP); Hiroshi Nakamura, Chiba-ken (JP); Hideo Ogawa, Chiba-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI TECHNO GLASS, Chiba (JP)

(21) Appl. No.: 10/542,099

(22) PCT Filed: Jan. 14, 2004
(86) PCT No.: PCT/JP04/00203

§ 371 Date: Jul. 13, 2005

(30) Foreign Application Priority Data
Jan. 14, 2003 (JP) 2003-006312

(51) Int. Cl. B28B 21/74; C03B 23/217; C03B 23/207

(52) U.S. Cl. 428/34.4; 65/43

(57) ABSTRACT

A glass tube (1) that is used in such a manner that an end face thereof is hermetically and firmly bonded to a surface of a panel (11) of a flat display tube so as to cover a ventilation hole (12) which is formed in the panel (11), the glass tube (1) including a flange portion (4) formed by heating work of the glass tube (1) and provided on an outer periphery near the end face on a side firmly bonded to the surface of the panel (11) of the flat display tube. When the flange portion (4) is formed, a tube end portion (2) protruding ahead of the flange portion (4) is left, so that a flange portion (4) face on a side facing the surface of the panel (11) of the flat display tube allows a frit glass (6) to be placed thereon, the frit glass (6) having a height equal to an interval (an outer peripheral face of the tube end portion) between the end face of the glass tube and the flange portion (4) face, which enables stable bonding of the glass tube (1) to the surface of the panel (11) of the flat display tube.

### TECHNICAL FIELD

The present invention relates to a glass tube used as an exhaust pipe or the like of a flat display tube.

### BACKGROUND ART

A flat display tube such as a plasma display panel (PDP), a field emission display (FED), a plasma address liquid crystal display (PALC), and a vacuum fluorescent display (VFD) has a glass tube called an exhaust pipe which is attached thereto to exhaust the inside or further supply gas to the inside after the exhaust.

Japanese Patent Laid-open Application No. Hei 9-35637 discloses a method for attaching a glass tube to a flat display tube in such a manner that the glass tube with a frit glass being joined to an end face thereof is vertically put on a panel of the flat display tube so as to cover a ventilation hole and it is baked while keeping this state.

This method is widely adopted but has a problem that it is very difficult to hermetically bond the glass tube to the panel in a good condition unless a jig is used for holding it since the glass tube used as the exhaust pipe is long and thin and thus is difficult to keep this posture while being baked.

Japanese Patent Laid-open Application No. 2001-84892 discloses a method in which one end of a glass tube is worked into a fanned-out shape such as a flared shape or a flange shape, and a frit glass is joined to this fanned-out end face in advance. As a method of joining the frit glass to the end face of the glass tube, this publication also describes a method in which the frit glass is fusion-bonded to the end face of the glass tube or an adhesive is used for bonding.

Japanese Patent Laid-open Application No. 2001-253724 discloses several methods for widening a contact area with a panel by using two different kinds of frit glasses in melting point to join a frit glass to an outer periphery of an end portion of a glass tube.

In one of these methods, a glass tube is inserted into a jig into which the glass tube is insertable and in which a hole having a depth shorter than the length of the glass tube is formed, and a high melting point frit glass in a ring-shape is thereafter disposed around an end portion of the glass tube protruding from the hole. On this high melting point frit glass, a low melting point frit glass is placed, and they are heated at a temperature that is not high enough for the low-meting point frit glass to greatly deform, so that the low melting point frit glass is joined to the glass tube and the high melting point frit glass.

### DISCLOSURE OF THE INVENTION

The method disclosed in Japanese Patent Laid-open Application No. 2001-84892 of joining the frit glass to the end face of the glass tube, however, has a problem that the frit glass softened by heating spreads on the panel due to its wettability and the weight of the glass tube to drip down into the hole formed in the panel. In the case of the method of joining the frit glass to the end face, it is possible to put the glass tube to the panel from under with its fanned-out end face facing upward (upside-down direction) when the glass tube is to be bonded to the panel. However, similarly to the above, problems arise that the frit glass softened by heating adheres to an inner face of the glass tube to lower the strength of the glass tube, and the softened frit glass drips down from the glass tube.

Further, also in the method disclosed in Japanese Patent Laid-open Application No. 2001-253724 in which two different kinds of the frit glasses in melting point are joined to the glass tube, if the low melting point glass is joined in a state of protruding from the end face of the glass tube, the end face of the glass tube is not in contact with the panel even if the glass tube is placed on the panel with its end face facing downward (forward direction). Joining the glass tube in this state causes a problem that the softened low melting point glass flows in a direction of the end face of the glass tube to drip down into the hole of the panel as in the aforesaid method. Further, when the direction of the glass tube is set horizontal or upside down, a problem arises that the high melting point glass also drips down along with the dripping of the low melting point glass, so that the glass tube cannot be bonded.

Therefore, it is an object of the present invention to provide a frit glass integrated glass tube that can be bonded in a good condition from any direction, a method of manufacturing the same, a glass tube used for the same, and a method of bonding the glass tube.

One of the aspects of the present invention is a glass tube that is used in such a manner that an end face thereof is hermetically and firmly bonded to a surface of a panel of a flat display tube so as to cover a ventilation hole formed in the panel, the glass tube including a flange portion formed by heating work of the glass tube and provided on an outer periphery near the end face on a side firmly bonded to the surface of the panel of the flat display tube.

When the flange portion is formed, a tube end portion protruding ahead of the flange portion is thus left, so that a flange portion face on a side facing the surface of the panel of the flat display tube allows a frit glass to be placed thereon, the frit glass having a height equal to an interval (an outer peripheral face of the tube end portion) between the end face of the glass tube and the flange portion face, which enables stable bonding of the glass tube to the surface of the panel of the flat display tube, as will be described later.

In the glass tube of the present invention, the glass tube preferably has, on the side bonded to the surface of the panel of the flat display tube, an inner peripheral face that fans out in a trumpet shape in a direction of the end face.

From a viewpoint of downsizing a glass tube while maintaining its strength without lowering its exhaust efficiency, it is generally preferable that an inside diameter of the glass tube is equal to a diameter of a ventilation hole provided in a panel of a flat display tube, in order to allow gas to easily pass therethrough at the time of the exhaust or gas supply, but if the center of the ventilation hole in the surface of the panel and the center of a hole of the glass tube do not coincide with each other when the glass tube is bonded to the surface of the panel of the flat display tube, the ventilation hole in the panel is partly overlapped with an end face of the glass tube, so that a necessary ventilation section cannot be obtained. On the other hand, fanning out the hole of the bonded side end portion of the glass tube makes it possible to secure the necessary ventilation section because the ventilation hole of the panel is not overlapped with the end face of the glass tube even if the both centers are slightly deviated from each other. Incidentally, if the entire end portion of the glass tube fans out in this case, bonding strength can be increased because a contact (bonded) area between the end face of the glass tube and the surface of the panel of the flat display tube becomes wider.

Further, the glass tube of the present invention can have a bent portion formed in an outer peripheral edge of the flange portion to bend toward the surface of the panel of the flat display tube. Thus forming the bent portion bending toward the surface of the panel of the flat display tube makes it possible to increase joint strength because a joined surface between the frit glass and the flange portion is made larger.

In the present invention, it is also possible to join a frit glass in advance to a surface of the glass tube to which the frit glass is to be joined. A position where the frit glass is joined is a position with which the frit glass comes into contact when the glass tube is bonded to the surface of the panel of the flat display tube, and for example, one place or a plurality of places is/are appropriately selected from the following: an outer periphery of the glass tube between its end face, which is to abut on the surface of the panel, and the flange portion; the flange portion face on the side facing the panel; an inner side of the bent portion in the peripheral edge of the flange portion; and so on.

Thus joining the frit glass in advance greatly improves operability when the glass tube is bonded to the surface of the panel of the flat display tube. Work is greatly facilitated especially when the glass tube is placed on the panel of the flat display tube, and when the end face of the glass tube is bonded to the surface of the panel that faces downward. Incidentally, when the glass tube set horizontal is bonded to the surface of the panel of the flat display tube, a joint area between the frit glass and the glass tube becomes wider in the course of bonding, starting from the joint portion, which prevents the frit glass from easily dripping. Note that “joined” used in the present invention means a state in which at least part of the frit glass is softened by heating to be partly welded and fixed to the glass tube.

When the glass tube with the flange portion which is flat, is set horizontal and bonded to the surface of the panel, the frit glass is preferably joined in advance both to the flange face and the outer periphery of the tube end portion, that is, a tip portion ahead of the flange portion. When the flange portion has the bent portion in its peripheral edge, the frit glass is preferably joined in advance to the inner face of the bent portion, or more preferably, both to the inner face of the bent portion and the outer periphery of the tube end portion, that is, the tip portion ahead of the flange portion.

The frit glass joined to the glass tube in advance is preferably formed in a ring shape before being joined. Forming it in the ring shape in advance facilitates joining the frit glass to the glass tube, so that selective joint to the flange face or the straight tube portion is also facilitated.

Preferably, when the frit glass is joined to the flange portion in advance, the end face of the glass tube on a side bonded to the surface of the panel and an end face of the frit glass are substantially flush with each other. Thus making the end face of the glass tube on the side bonded to the surface of the panel and the end face of the frit glass substantially flush each other makes it possible to prevent the frit glass, even if being softened, from seeping out to an inside diameter side of the glass tube because the end face of the glass tube surely comes into contact with the surface of the panel when the glass tube is bonded.

“Being substantially flush with each other” mentioned here does not necessarily mean a state in which the end face of the glass tube and the end face of the frit glass become completely flush with each other before the glass tube is bonded to the surface of the panel, but it suffices if there is planarity to an extent such that the glass tube is bonded to the panel via the frit glass while the end face of the glass tube is surely in contact with the surface of the panel when the glass tube is bonded to the panel, and a case where there is a slight level difference is also included.

That is, the end face of the frit glass may be slightly indented or protruded from the end face of the glass tube. Specifically, if the end face of the frit glass is indented by less than 5 mm or protruded by less than 1 mm, good bonding is achieved regardless of the direction of the glass tube.

The frit glass can be joined to the glass tube in advance by the following method. Specifically, first, a flange is formed near one end of a straight glass tube by using a jig. Next, a frit glass formed in a ring shape in advance is placed on a ceramic substrate, a tip portion ahead of the flange in the glass tube is inserted into a hole of the frit glass, and they are heated in this state, so that the frit glass is joined to the glass tube.

Thus joining, on the ceramic substrate, the frit glass to the end portion of the glass tube makes it possible to easily make the end face of the glass tube substantially flush with the end face of the frit glass.

The flange portion of the glass tube preferably has, in an outer periphery thereof, a bent portion bending toward the end face of the glass tube on a side to be bonded. Further, an inner peripheral face thereof preferably has a trumpet shape fanning out toward the tip. Further, a glass tube whose outer periphery as well as the inner peripheral face fans out toward the end portion is also usable.

In the glass tube to which the ring-shaped frit glass is joined by this method, the end face of the glass tube comes into contact with the ceramic substrate owing to the own weight of the glass tube when the frit glass is softened, even if the thickness of the frit glass formed in the ring shape is larger than the length between the flange portion face and the end face of the glass tube, so that it is possible to make the end face of the glass tube and the end face of the frit glass substantially flush with each other. Further, when the thickness of the frit glass is smaller than the length between the flange portion face and the end face of the glass tube, these end faces can be of course made flush with each other without difficulty.

When a ceramic substrate whose main component is aluminum nitride is used as the ceramic substrate used in the above-described method, a component of the frit glass and the component of the substrate do not react with each other at a temperature that is only high enough to soften the frit glass because amount of an oxygen atom contained in the whole substrate is small and an Al atom and an N atom are firmly bonded by covalent bond. Therefore, the frit glass does not adhere on the substrate, so that the glass tube and the frit glass can be joined in a good condition.

To bond the glass tube with the frit glass joined thereto to the surface of the panel, in which the ventilation hole is formed, of the flat display tube, the following steps are performed: a step of bringing the end face of the glass tube on a side to which the frit glass is joined into contact with the surface of the panel so that the glass tube covers the ventilation hole, and holding the glass tube; a step of raising a temperature of at least contact portions of the glass tube, the frit glass and the panel to a temperature that is higher than a softening point of the frit glass by 5 to 10% in Celsius; a step of keeping at least the contact portions of the glass tube, the frit glass and the panel at the raised temperature for 10 to 30 minutes; and a step of lowering the temperature of at least the contact portions of the glass tube, the frit glass and the panel to a predetermined temperature (temperature at which work of a subsequent step can be performed, normally a room temperature) from the raised temperature.

Such bonding to the panel at the temperature that is higher than the softening point of the frit glass by 5 to 10% in Celsius prevents the frit glass from dripping down from the glass tube even when the glass tube is bonded in a horizontal direction or from under, so that good bonding is enabled.

Further, the glass tube to which the frit glass is joined can also be bonded to the surface of the panel, in which the ventilation hole is formed, of the flat display tube, by the following steps: a step of bringing the end face of the glass tube on a side to which the frit glass is joined into contact with the surface of the panel so that the glass tube covers the ventilation hole, and holding the glass tube; a step of raising a temperature of at least contact portions of the glass tube, the frit glass and the panel to a temperature that is higher than a softening point of the frit glass by 5 to 10% in Celsius; a first keeping step of keeping at least the contact portions of the glass tube, the frit glass and the panel at the raised temperature for 10 to 30 minutes; a second keeping step of keeping a temperature equal to or higher than a temperature close to a transition point of the frit glass from the kept temperature of the first keeping step; and lowering the temperature of at least the contact portions of the glass tube, the frit glass and the panel to a predetermined temperature from the kept temperature of the second keeping step.

The time period in which the temperature is kept equal to or higher than the temperature close to the transition point is provided in the course of lowering the temperature, so that a crack is prevented from occurring due to an influence of a difference in thermal expansion between the glass tube and the frit glass, which can widen conditions under which good bonding can be performed.

### BRIEF DESCRIPTION OF DRAWINGS

FIG. 1 is a cross-sectional view of a glass tube of the present invention.

FIG. 2 is a view of the glass tube in FIG. 1 seen from its end face side.

FIG. 3 is a cross-sectional view of a glass tube according to another example.

FIG. 4 is a cross-sectional view of a glass tube according to another example.

FIG. 5 is a cross-sectional view of a glass tube according to another example.

FIG. 6 is a cross-sectional view of a glass tube in which a bent portion is formed on an outer periphery of its flange portion.

FIG. 7 is a side view of another example of the glass tube.

FIG. 8 is a cross-sectional view of a glass tube according to another example.

FIG. 9 is a cross-sectional view of a glass tube according to another example.

FIG. 10 is a cross-sectional view when a frit glass is joined to the glass tube in FIG. 1.

FIG. 11 is a cross-sectional view when a frit glass is joined to the glass tube in FIG. 3.

FIG. 12 is a cross-sectional view when a frit glass is joined to the glass tube in FIG. 4.

FIG. 13 is a cross-sectional view when a frit glass is joined to the glass tube in FIG. 6.

FIG. 14 is a cross-sectional view when a frit glass is joined to the glass tube in FIG. 8.

FIG. 15 is a conceptual view when a glass tube is bonded in an upside-down direction.

### BEST MODE FOR CARRYING OUT THE INVENTION

A glass tube 1 of the present invention is made of soda-lime glass including the composition of 70 to 74 mass % of SiO₂, 0 to 2 mass % of Al₂O₃, 6 to 12 mass % of CaO, 0 to 4 mass % of MgO, and 12 to 16 mass % of Na₂O. This glass tube is formed in such a manner that a straight tube formed to have a prescribed dimension of a 3 mm inside diameter and a 5 mm outside diameter is cut to a predetermined length, the vicinity of one end of the straight-tube glass is thereafter softened by heating, and a flange portion 4 is formed by using a jig so that a tube end portion 2 protrudes therefrom. Note that a coefficient of thermal expansion of this glass tube is 79 to 89×10⁻⁷/° C. and a softening point thereof is 720 to 730° C.

Further, an inside diameter portion of the glass tube 1 is formed in a flared shape that fans out toward its end face, and this structure prevents a trouble in exhaust and gas supply since a predetermined flow path section is secured even when the glass tube 1 is bonded in a state in which an axis of the inside diameter and an axis of a hole formed in a panel do not coincide with each other. Incidentally, in the above description, the straight tube is reworked by heating, thereby forming the flange portion 4, but a part formed by heating may be welded to the straight tube for forming the flange portion 4.

For forming a frit glass 6 used in the present invention, granulated glass of a raw material of lead-based type, lead-free type, or the like is pulverized to a predetermined particle size or smaller, and after a binder is added for size enlargement, the glass is pressed into a ring shape by using a mold. A refractory filler can be added to the frit glass 6 in order to adjust its coefficient of thermal expansion.

A frit glass integrated glass tube of the present invention is formed of the aforesaid glass tube 1 and frit glass 6 that are joined together by softening the frit glass 6. For forming this frit glass integrated glass tube, the frit glass 6 formed in the ring shape is placed on a ceramic substrate, and after the tube end portion 2 of the glass tube 1 is subsequently inserted in the ring of the frit glass 6 so as to stand on the ceramic substrate, the frit glass 6 that is softened by being heated nearly to the softening point of the frit glass 6 is joined to a flange portion face 5 and an outer peripheral face of the tube end portion 2 in the glass tube 1.

Incidentally, when the tube end portion 2 of the glass tube 1 is inserted into the ring of the frit glass 6 on the ceramic substrate, if the thickness of the frit glass 6 is larger than the length between the flange portion face 5 and an end face 3 of the glass tube, the glass tube 1 stands upright, being supported by the flange portion face 5 that is in contact with the frit glass 6. In this state, the glass tube 1 presses with its own weight the frit glass 6 softened by heating, so that the end face 3 of the glass tube comes into contact with the ceramic substrate, and consequently, an end face 7 of the frit glass and the end face 3 of the glass tube become substantially flush with each other while the frit glass 6 is joined to the flange portion face 5 and the outer peripheral face of the tube end portion 2.

On the other hand, when the thickness of the frit glass 6 is equal or smaller, the end face 3 of the glass tube is in contact with the ceramic substrate from the beginning, so that the end face 7 of the frit glass and the end face 3 of the glass tube are substantially flush with each other while the softened frit glass 6 is joined to the outer peripheral face of the tube end portion 2 of the glass tube 1 and the flange portion face 5, or only to the outer peripheral face of the tube end portion 2.

Another method capable of joining the frit glass 6 to the glass tube 1 is a method in which the tube end portion 2 of the glass tube 1 is set to face upward, the tube end portion 2 of the glass tube 1 is inserted in the frit glass 6 formed in the ring shape to be placed on the flange portion face 5, and the frit glass 6 is softened by heating. However, when the frit glass 6 is joined by this method, it is difficult to make the end face 7 of the frit glass and the end face 3 of the glass tube substantially flush with each other, and therefore, productivity is lowered when the glass tube 1 is set horizontal or upside down to be bonded to the panel.

### Embodiment 1

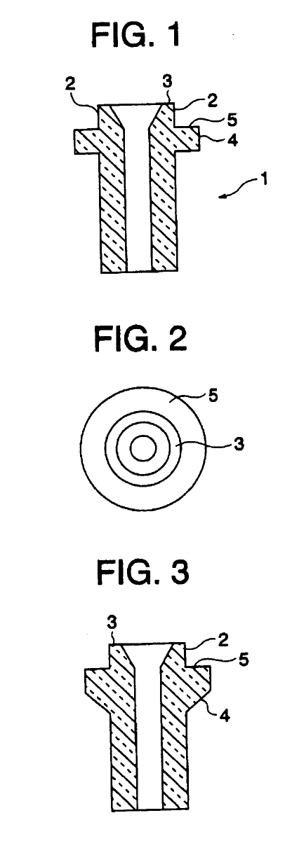

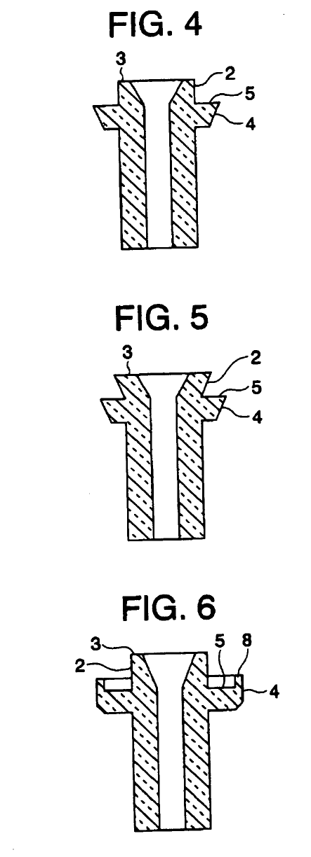

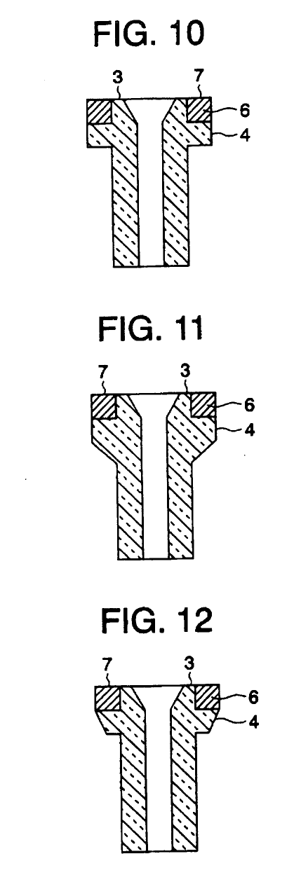

A glass tube 1 of the present invention will be described with reference to FIG. 1 to FIG. 10.

FIG. 1 shows an example (a cross section) of the glass tube 1 of the present invention, which is formed by using a straight tube that is formed of soda-lime glass having the aforesaid glass composition by using a Danner process or the like, and a flange portion face 5 is worked into a planar shape, the outside diameter of a tube end portion 2 is made equal to the diameter of the straight tube, and the inside diameter thereof is fanned out. Note that a coefficient of thermal expansion of the glass tube 1 used here is 84×10⁻⁷/° C. and a softening point thereof is 725° C.

When seen from a direction of an end face 3 of the glass tube, the flange portion face 5 in FIG. 1 has a shape such that the straight tube is positioned at the center of a circular flange portion 4 as shown in FIG. 2. The flange portion 4 is thus continuously formed around an outer periphery of the straight tube, so that a joint surface becomes large when a frit glass 6 is joined to the flange portion face 5, and therefore, when a frit glass integrated glass tube is set horizontal or upside down to be bonded to a panel, the softened frit glass 6 does not easily drip down. Incidentally, the flange portion 4 in a polygonal shape instead of the circular shape can also provide the same effect as long as the flange portion 4 is continuously formed.

FIG. 3 to FIG. 5 show glass tubes 1 according to other examples. In FIG. 5, an outer periphery of a tube end portion 2 is also worked into a flared shape, so that an area of an end face 3 of the glass tube is larger than that in FIG. 1, which makes it possible to bond the glass tube 1 to a panel without any inclination relative to the panel 1. Moreover, the length of the end face 3 of the glass tube from an outer peripheral face of the tube end portion 2 to an inner face of the glass tube 1 becomes longer, which increases a possibility that the end face 3 of the glass tube can prevent a frit glass 6 from entering the inner face of the glass tube 1 and a hole of the panel even when the frit glass 6 flows in an inside diameter direction.

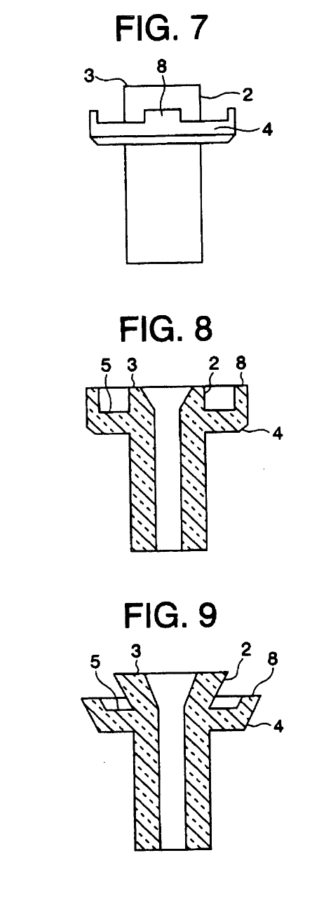

FIG. 6 is an example of a modified flange portion 4, and an outer periphery of the flange portion 4 is bent in a direction of a tube end portion 2 to form a bent portion 8. By thus forming the bent portion 8, a face to which a frit glass 6 can be joined is made larger. Then, if the frit glass is joined also to part of the bent portion 8 when the frit glass is joined to the glass tube, a joint area between the glass tube and the frit glass is increased, which makes it further difficult for the softened frit glass 6 to drip down when the glass tube is bonded. In the example in FIG. 6, the bent portion 8 is formed along the whole periphery of the flange portion 4, but a plurality of bent portions 8 may be formed at spaced intervals as shown in FIG. 7.

Incidentally, though an edge of the bent portion 8 shown in FIG. 6 does not extend to a position of an end face 3 of the glass tube, it may extend to a position that is flush with the end face 3 of the glass tube as shown in FIG. 8. In this case, however, unless a frit glass 6 is fitted in an area formed by the bent portion 8 and an outer periphery of a tube end portion 2 as well as the thickness of the frit glass 6 is made equal to or smaller than the length between a flange portion face 5 and the end face 3 of the glass tube, it might not be possible to make an end face of the frit glass 6 and the end face 3 of the glass tube flush with each other even when the frit glass 6 is softened.

Further, since the bent portion 8 is intended for auxiliary functioning to prevent the frit glass 6 from dripping down when the glass tube 1 is bonded, a bent angle of the bent portion 8 may be small as shown in FIG. 9.

### Embodiment 2

A preferable frit glass integrated glass tube of the present invention is formed by joining a frit glass 6 to a glass tube 1 on a ceramic substrate, and therefore, this manufacturing method will be described below. Note that physical characteristics such as a coefficient of thermal expansion and a softening point of the glass tube 1 used here are the same as those in the above-described embodiment 1.

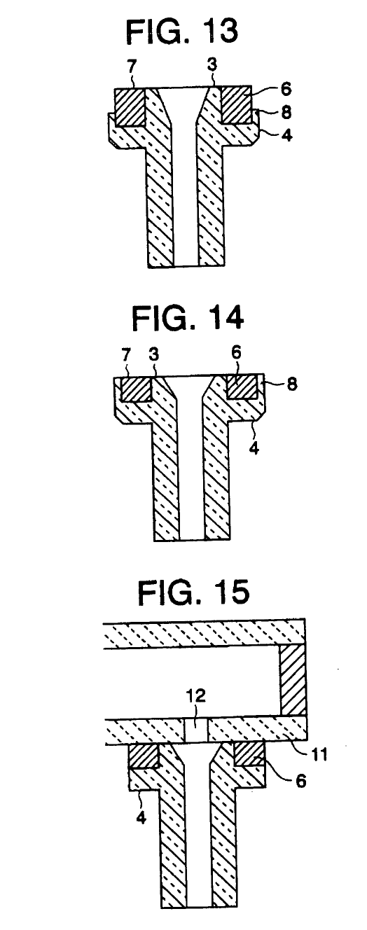

First, the frit glass 6 formed in a ring shape on the ceramic substrate and the glass tube 1 are set at predetermined positions, the temperature thereof is raised to a level not high enough for the frit glass 6 to greatly change in its shape, the temperature is kept in this state for about 10 minutes to join the frit glass 6 to a flange portion face 5 of the glass tube 1 and an outer peripheral face of a tube end portion 2, and next, the temperature is lowered to a room temperature, whereby the frit glass integrated glass tube of the present invention is obtained (see FIG. 11 to FIG. 14).

The following table 1 shows the summary of materials tested in this method.

TABLE 1

| | Main Component, | | Evalua- |
|---|---|---|---|
| Material | etc. | Result | tion |
| aluminum | AlN 98.8% | no adhesion of frit | good |
| nitride | Y₂O₃ 1.2% | glass to substrate | |
| substrate 1 | | | |
| aluminum | AlN 98.7% | no adhesion of frit | good |
| nitride | Y₂O₃ 1.2% | glass to substrate | |
| substrate 2 | V₂O₅ 0.1% | | |
| aluminum | AlN 97.6% | no adhesion of frit | good |
| nitride | Y₂O₃ 2.4% | glass to substrate | |
| substrate 3 | | | |
| alumina | A1₂O₃ 99.5% or | adhesion of part of | moderate |
| substrate | more | frit glass to | |
| | | substrate | |
| SUS304 | surface coated | adhesion of frit glass | no good |
| surface-treated | with Al₂O₃film | to substrate | |

As shown in Table 1, good result was obtained with the ceramic substrates which had little adhesion of the frit glass 6. It has been found that the aluminum nitride substrate in particular is a preferable material since the frit glass 6 did not adhere thereto at all. Further, the alumina substrate is evaluated as “moderate”, because, though the frit glass 6 adhered to the substrate, only part of the outer most periphery of the frit glass 6 adhered and the adhesion was only to a degree that was not significant at the time of bonding to the panel. As a comparative example, a substrate on whose metal surface an Al₂O₃ film was formed was used, but the frit glass 6 adhered to the substrate, and an attempt to forcibly peel off the frit glass 6 only resulted in coming off of the glass tube 1.

### Embodiment 3

Here, a bonding method when a frit glass integrated glass tube of the present invention is set horizontal or upside down to be bonded to a panel will be shown. Note that a coefficient of thermal expansion of a panel glass used here was 83×10⁻⁷/° C. and a softening point thereof was 830° C., and a glass tube used here had the same physical characteristics as those in the Embodiments 1, 2 described above.

When the frit glass integrated glass tube is placed on the panel to be bonded to the panel by temperature rise as has been conventionally practiced, it is possible to bond the glass tube 1 if only the frit glass 6 is melted by the temperature rise. However, when the glass tube 1 is set horizontal or upside down, unless bonding conditions of the frit glass 6 are controlled, the frit glass 6 drips down even if a face to which the frit glass 6 is joined is made larger in the glass tube 1, and therefore, it is not possible to bond the glass tube 1. FIG. 15 shows a conceptual view when the glass tube 1 is set upside down to be bonded to the panel. In this drawing, the reference numeral 11 denotes a panel and 12 denotes a hole (ventilation hole).

Here, tests were conducted under temperature rise conditions and bonding conditions as shown in Table 2 to find optimum bonding conditions. As frit glasses 6 used here (the number of samples 10), those having a coefficient of thermal expansion of 72×10⁻⁷/° C., a transition point of 320° C., and a softening point of 400° C. were used.

TABLE 2

| | | Temp. | | |
|---|---|---|---|---|
| Temp. Rise | Joining | Lowering | | Evalua- |
| Condition | Condition | Condition | Bonded State | tion |
| room temp.→ | 415° C.: 10 min. | 415° C.→ | none bonded | no good |
| 415° C.: | 415° C.: 20 min. | room | none bonded | no good |
| 1.5 hours | 415° C.: 30 min. | temp.: | few bonded | no good |
| | | 1 hour | | |
| room temp.→ | 420° C.: 10 min. | 420° C.→ | few bonded | no good |
| 420° C.: | 420° C.: 20 min. | room | some bondable | no good |
| 1.5 hours | 420° C.: 30 min. | temp.: | peeling | mod- |
| | | 1 hour | occurred in | erate |
| | | | some | |
| room temp.→ | 425° C.: 10 min. | 425° C.→ | some bondable | no good |
| 425° C.: | 425° C.: 20 min. | room | peeling | mod- |
| 1.5 hours | | temp.: | occurred in | erate |
| | | 1 hour | some | |
| | 425° C.: 30 min. | | good bonding | good |
| room temp.→ | 430° C.: 10 min. | 430° C.→ | peeling | mod- |
| 430° C.: | | temp.: | occurred in | erate |
| 1.5 hours | | room | some | |
| | 430° C.: 20 min. | 1 hour | good bonding | good |
| | 430° C.: 30 min. | | hanging-down | mod- |
| | | | occurred in | erate |
| | | | some | |
| room temp.→ | 435° C.: 10 min. | 435° C.→ | good bonding | good |
| 435° C.: | 435° C.: 20 min. | room | hanging-down | mod- |
| 1.5 hours | | temp.: | occurred in | erate |
| | | 1 hour | some | |
| | 435° C.: 30 min. | | hanging-down | mod- |
| | | | occurred in | erate |
| | | | some | |

In the above evaluation “good”: 9 to 10 good products, “moderate”: 6 to 8 good products, “no good”: 5 good products or less.

In the results in Table 2, among samples under the condition where the temperature was raised from a room temperature to 415° C. in 1.5 hours, a sample having good bonding was hardly obtained even when the keeping time at 415° C. was changed from 10 minutes to 30 minutes. However, since a few of them were bondable when the keeping time was 30 minutes, bonding is possible if the keeping time is made longer.

Among samples under the condition where the temperature was raised from a room temperature to 420° C. in 1.5 hours, good bonding was obtained with more than half of the samples when the keeping time at 420° C. was 30 minutes. However, defective samples included those in which the frit glass 6 peeled off due to a crack or the like occurring between the glass tube 1 and the frit glass 6.

Among samples under the condition where the temperature was raised from a room temperature to 425° C. in 1.5 hours, good bonding was obtained with some samples even when the keeping time at 425° C. was 10 minutes, and good bonding was obtained with all when the keeping time was 30 minutes. Defective samples under this joining condition also included those whose glass tube 1 easily came off due to a crack or the like, similarly to the defective samples under the aforesaid joining condition at 420° C.

Among samples under the condition where the temperature was raised from a room temperature to 430° C. in 1.5 hours, good bonding was obtained with nearly all even when the keeping time at 430° C. was changed from 10 minutes up to 30 minutes. However, when the keeping time was 30 minutes, the frit glass 6 was excessively softened, and in some samples, the frit glass 6 spread out from the flange portion face 5. However, the softening did not go so far as to cause the frit glass 6 to drip down.

Among samples under the condition where the temperature was raised from a room temperature to 435° C. in 1.5 hours, good bonding was obtained with all when the keeping time at 435° C. was 10 minutes. However, when the keeping time was made longer to 20 minutes and to 30 minutes, the frit glass 6 hung down to spread out from the flange portion face 5 in some samples, similarly to the samples whose temperature was raised up to 430° C.

It has been found from the above-described results that good bonding can be achieved under the condition where a temperature that is higher than the softening point of the frit glass 6 by about 5 to 10% is kept for 10 to 30 minutes, even when the glass tube 1 is set horizontal or upside down.

Next, tests were conducted under the condition where the temperature was raised from a room temperature to 425° C. in 1.5 hours and 425° C. was kept for 20 minutes, with varied temperature lowering conditions, and the results thereof are shown in Table 3. As frit glasses 6 used here (the number of samples 10), the same frit glasses as those used in the aforesaid tests were used, namely, a coefficient of thermal expansion thereof was 72×10⁻⁷/° C., a transition point was 320° C., and a softening point was 400° C.

TABLE 3

| Temp. Lowering | Keeping | Temp. Lowering | Bonded | Evalua- |
|---|---|---|---|---|
| Condition(1) | Condition | Condition(2) | State | tion |
| 425° C.→ | | | peeling | mod- |
| room temp.: | | | occurred | erate |
| 1 hour | | | in some | |
| 425° C.→250° C.: | 250° C.: | 250° C.:→ room | no change | mod- |
| 1 hour | 10 min. | temp.: | from the | erate |
| | | 1 hour | state | |
| | | | with no | |
| | | | keeping | |
| | | | condition | |
| | 250° C.: | | no change | mod- |
| | 20 min. | | from the | erate |
| | | | state | |
| | | | with no | |
| | | | keeping | |
| | | | condition | |
| 425° C.→310° C.: | 310° C.: | 310° C.:→room | good | good |
| 1 hour | 10 min. | temp.: | bonding | |
| | 310° C.: | 1 hour | good | good |
| | 20 min. | | bonding | |
| 425° C.→320° C.: | 320° C.: | 320° C.:→room | good | good |
| 1 hour | 10 min. | temp.: | bonding | |
| | 320° C.: | 1 hour | good | good |
| | 20 min. | | bonding | |
| 425° C.→330° C.: | 330° C.: | 330° C.:→room | good | good |
| 1 hour | 10 min. | temp.: | bonding | |
| | 330° C.: | 1 hour | good | good |
| | 20 min. | | bonding | |
| 425° C.→370° C.: | 370° C.: | 370° C.:→room | good | good |
| 1 hour | 10 min. | temp.: | bonding | |
| | 370° C.: | 1 hour | good | good |
| | 20 min. | | bonding | |

In the above evaluation, “good”: 9 to 10 good products, “moderate”: 6 to 8 good products, “no good”: 5 good products or less.

From the results in Table 3, no effect was obtained even when the temperature was once kept at a level greatly lower than the transition point of the frit glass 6, but when the temperature was once kept at a level equal to or higher than a temperature close to the transition point, no crack between the glass tube 1 and the frit glass 6 occurred and the number of good products was larger than that when no keeping time was provided in the course of temperature lowering.

### INDUSTRIAL APPLICABILITY

As has been described hitherto, in the glass tube 1 of the present invention, the flange portion 4 is formed so that the tube end portion 2 protrudes therefrom, and accordingly, the outer peripheral face of the tube end portion 2 and the flange portion face 5 both serve as faces to which the frit glass 6 is joined, so that it is possible to obtain the frit glass integrated glass tube in which the frit glass 6 is firmly joined to the glass tube 1. Therefore, the use of this frit glass integrated glass tube enables good bonding to the panel not only when the glass tube 1 is set in the forward direction, that is, when the end face 3 of the glass tube faces downward, but also when the glass tube 1 is set horizontal and upside down.

1-12. (canceled)

13. A glass tube used such that an end face thereof is brought into contact with a surface of a panel of a flat display tube so as to cover a ventilation hole formed in the panel and the end face is hermetically bonded with a frit glass, the glass tube comprising:
a flange portion formed by heating work of the glass tube and provided near the end face on a side brought into contact with the surface of the panel of the flat display tube; and
wherein the first glass is joined to at least one of a face of said flange portion as a side facing the end face and an outer peripheral face between said flange portion and the end face in said glass tube.

14. The glass tube as set forth in claim 13, wherein the glass tube includes, on the side firmly bonded to the surface of the panel of the flat display tube, an inner peripheral face that fans out in a direction of the end face.

15. The glass tube as set forth in claim 13, wherein said flange portion has in an outer peripheral edge thereof a bent portion bending toward the surface of the panel of the flat display tube.

16. The glass tube as set forth in claim 13, wherein said frit glass is formed in a ring shape.

17. The glass tube as set forth in claim 13, wherein the end face of the tube end portion and an end face of said frit glass are substantially flush with each other.

18. A method of manufacturing a glass tube to which a frit glass is joined, the method comprising:
forming a flange portion by heating work on an outer periphery near an end portion in one end of a straight glass tube;
placing on a ceramic substrate a frit glass formed in a ring shape;
inserting into the ring the end portion of the glass tube on a side having the flange portion; and
heating the frit glass to join the frit glass to the glass tube.

19. The method of manufacturing the glass tube to which the frit glass is joined as set forth in claim 18, wherein the end portion of the glass tube has an inner peripheral face that fans out in a direction of an end face.

20. The method of manufacturing the glass tube to which the frit glass is joined as set forth in claim 18, wherein the flange portion has in an outer peripheral edge thereof a bent portion bending toward a surface of a panel of the flat display tube.

21. The method of manufacturing the glass tube to which the frit glass is joined as set forth in claim 18, wherein a main component of the ceramic substrate is aluminum nitride.

22. A method of bonding the glass tube to which the frit glass as set forth in claim 13 is joined to the surface of the panel, in which the ventilation hole is formed, of the flat display tube, the method comprising:
bringing the end face of the glass tube on a side to which the frit glass is joined into contact with the surface of the panel so that the glass tube covers the ventilation hole, and holding the glass tube;
raising a temperature of at least contact portions of the glass tube, the frit glass, and the panel to a temperature that is higher than a softening point of the frit glass by 5 to 10% in Celsius;
keeping at least the contact portions of the glass tube, the frit glass, and the panel at the raised temperature for 10 to 30 minutes; and
lowering the temperature of at least the contact portions of the glass tube, the frit glass, and the panel to a predetermined temperature from the raised temperature.

23. A method of bonding the glass tube to which the frit glass as set forth in 13 is joined to the surface of the panel, in which the ventilation hole is formed, of the flat display tube, the method comprising:
bringing the end face of the glass tube on a side to which the frit glass is joined into contact with the surface of the panel so that the glass tube covers the ventilation hole, and holding the glass tube;
raising a temperature of at least contact portions of the glass tube, the frit glass, and the panel to a temperature that is higher than a softening point of the frit glass by 5 to 10% in Celsius;
first keeping at least the contact portions of the glass tube, the frit glass, and the panel at the raised temperature for 10 to 30 minutes;
second keeping a temperature equal to or higher than a temperature close to a transition point of the frit glass from the kept temperature of said first keeping; and
lowering the temperature of at least the contact portions of the glass tube, the frit glass, and the panel to a predetermined temperature from the kept temperature of said second keeping.

24. The glass tube as set forth in claim 14, wherein said flange portion has in an outer peripheral edge thereof a bent portion bending toward the surface of the panel of the flat display tube.

25. The glass tube as set forth in claim 15, wherein an end face of the tube end portion and an end face of said frit glass are substantially flush with each other.

26. The method of manufacturing the glass tube to which the frit glass is joined as set forth in claim 19, wherein the flange portion has in an outer peripheral edge thereof a bent portion bending toward a surface of a panel of the flat display tube.

27. The method of manufacturing the glass tube to which the frit glass is joined as set forth in claim 19, wherein a main component of the ceramic substrate is aluminum nitride.

28. A method of bonding the glass tube to which the frit glass as set forth in claim 19 is joined to the surface of the panel, in which the ventilation hole is formed, of the flat display tube, the method comprising:
bringing the end face of the glass tube on a side to which the frit glass is joined into contact with the surface of the panel so that the glass tube covers the ventilation hole, and holding the glass tube;
raising a temperature of at least contact portions of the glass tube, the frit glass, and the panel to a temperature that is higher than a softening point of the frit glass by 5 to 10% in Celsius;
keeping at least the contact portions of the glass tube, the frit glass, and the panel at the raised temperature for 10 to 30 minutes; and
lowering the temperature of at least the contact portions of the glass tube, the frit glass, and the panel to a predetermined temperature from the raised temperature.

29. A method of bonding the glass tube to which the frit glass as set forth in claim 15 is joined to the surface of the panel, in which the ventilation hole is formed, of the flat display tube, the method comprising:
bringing the end face of the glass tube on a side to which the frit glass is joined into contact with the surface of the panel so that the glass tube covers the ventilation hole, and holding the glass tube;
raising a temperature of at least contact portions of the glass tube, the frit glass, and the panel to a temperature that is higher than a softening point of the frit glass by 5 to 10% in Celsius;
first keeping at least the contact portions of the glass tube, the frit glass, and the panel at the raised temperature for 10 to 30 minutes;
second keeping a temperature equal to or higher than a temperature close to a transition point of the frit glass from the kept temperature of said first keeping; and
lowering the temperature of at least the contact portions of the glass tube, the frit glass, and the panel to a predetermined temperature from the kept temperature of said second keeping.

30. A method of bonding the glass tube to which the frit glass as set forth in claim 17 is joined to the surface of the panel, in which the ventilation hole is formed, of the flat display tube, the method comprising:
bringing the end face of the glass tube on a side to which the frit glass is joined into contact with the surface of the panel so that the glass tube covers the ventilation hole, and holding the glass tube;
raising a temperature of at least contact portions of the glass tube, the frit glass, and the panel to a temperature that is higher than a softening point of the frit glass by 5 to 10% in Celsius;
keeping at least the contact portions of the glass tube, the frit glass, and the panel at the raised temperature for 10 to 30 minutes; and
lowering the temperature of at least the contact portions of the glass tube, the frit glass, and the panel to a predetermined temperature from the raised temperature.

31. A method of bonding the glass tube to which the frit glass as set forth in claim 17 is joined to the surface of the panel, in which the ventilation hole is formed, of the flat display tube, the method comprising:
bringing the end face of the glass tube on a side to which the frit glass is joined into contact with the surface of the panel so that the glass tube covers the ventilation hole, and holding the glass tube;
raising a temperature of at least contact portions of the glass tube, the frit glass, and the panel to a temperature that is higher than a softening point of the frit glass by 5 to 10% in Celsius;
first keeping at least the contact portions of the glass tube, the frit glass, and the panel at the raised temperature for 10 to 30 minutes;
second keeping a temperature equal to or higher than a temperature close to a transition point of the frit glass from the kept temperature of said first keeping; and
lowering the temperature of at least the contact portions of the glass tube, the frit glass, and the panel to a predetermined temperature from the kept temperature of said second keeping.
